(19) United States
(12) Patent Application Publication
(10) Pub. No.: US 2010/0285429 A1
(43) Pub. Date: Nov. 11, 2010

(54) COMPOUND SMC DENTAL MILL BLANKS

(76) Inventors: Naimul Karim, Maplewood, MN (US); Sumita B. Mitra, West St. Paul, MN (US)

Correspondence Address: 3M INNOVATIVE PROPERTIES COMPANY, PO BOX 33427, ST. PAUL, MN, 55133-3427, US

(21) Appl. No.: 12/742,265

(22) PCT Filed: Nov. 18, 2008
(86) PCT No.: PCT/US08/83886

§ 371 Date: May 11, 2010

Related U.S. Application Data
(60) Provisional application No. 60/990,678, filed on Nov. 28, 2007.

(51) Int. Cl. A61C 13/087; A61C 13/003; A61C 13/23; A61C 5/10; G06K 19/06

(52) U.S. Cl. 433/199.1; 433/203.1; 433/226; 29/896.1; 235/494

(57) ABSTRACT

A dental mill blank is formed from a number of different self-supporting, malleable, curable (SMC) materials distributed within the blank so that a dental article machined from the blank closely resembles natural dentition in appearance or function. When in an uncured state, a single mill blank can be adapted to fit a variety of different tooth sizes and shapes, thus reducing the inventory of mill blank types required for fabrication of the range of possible tooth shapes and sizes.

### CROSS-REFERENCE TO RELATED APPLICATIONS

This application claims the benefit of U.S. Provisional Patent Application No. 60/990,678, filed Nov. 28, 2007.

### BACKGROUND

1. Field of the Invention

The invention relates to dentistry, and more particularly to dental mill blanks formed from a number of different self-supporting, malleable, curable materials having different properties so that dental articles machined from the blanks can more closely match the optical and structural properties of natural dentition.

2. Description of the Related Art

One technique for fabricating crowns and other dental articles employs a computer-controlled milling machine to shape a mill blank into a desired end product. Most commercially available mill blanks are made of ceramic or some other material suitably hard for use in a final dental restoration, such as porcelain or micaceous ceramics. A disadvantage arising from these existing mill blanks is the monochromatic appearance and uniform structural characteristics of the resulting, milled product. In principle, a compound mill blank can be constructed with an interior having one set of desired structural and optical properties and an exterior having a different set of desired structural and optical properties. This compound mill blank could then be milled into a multi-chromatic dental article that closely corresponds in appearance and structural characteristics to a human tooth. However, the wide variation in size, shape, and function of human teeth would require such a large number of different blanks as to render this approach impractical for individual dentists, and even large, commercial dental laboratories. There are no notable commercial providers of dental milling solutions that offer compound mill blanks.

There remains a need for compound mill blanks suitable for use in the manufacture of dental articles.

### SUMMARY

A dental mill blank is formed from a number of different self-supporting, malleable, curable (SMC) materials distributed within the blank so that a dental article machined from the blank closely resembles natural dentition in appearance or function. When in an uncured state, a single mill blank can be adapted to fit a variety of different tooth sizes and shapes, thus reducing the inventory of mill blank types required for fabrication of the range of possible tooth shapes and sizes.

In one aspect, a dental mill blank described herein includes two or more materials, the two or more materials being self-supporting, malleable, curable (SMC) materials, and the two or more materials including an internal material having one or more optical properties similar to dentin and an exterior material having one or more optical properties similar to enamel, the internal material and the external material being spatially distributed within the dental mill blank in a manner substantially corresponding to a distribution, in a cured and milled dental article, of dentin and enamel in a natural tooth structure.

The cured and milled dental article may include a restoration. The restoration may include one or more of a crown, a bridge, an inlay, and an onlay. The natural tooth structure may include a tooth of a predetermined size. The dental mill blank may include a bar code affixed to the dental mill blank. The bar code may identify a distribution of the two or more materials by reference to one or more of a size, a shade, and a type of a dental article to be fabricated for the natural tooth structure from the dental mill blank. The bar code may identify the dental mill blank according to one or more of a batch number, a shape, and a shelf life. The two or more materials may include an interior material resistant to fracture and an exterior material providing one or more characteristics similar to enamel. The one or more characteristics may include one or more of chip resistance, stain resistance, wear resistance, and polish retention. At least one of the SMC materials may include a resin system with a crystalline component, a filler system, and an initiator system. The at least one of the SMC materials may include: a resin system comprising at least one ethylenically unsaturated component and a crystalline component; greater than 60 wt-% of a filler system; and an initiator system; wherein the SMC material exhibits sufficient malleability at a temperature of about 15° C. to 38° C. At least one of the SMC materials may include a polymerizable compound and an organogelator. The organogelator may include a polymerizable organogelator.

In another aspect, a dental mill blank described herein includes two or more materials, the two or more materials being self-supporting, malleable, curable (SMC) materials, and the two or more materials including an internal material having one or more mechanical properties to support a tooth structure and an exterior material having one or more mechanical properties similar to enamel, the external material being spatially distributed within the dental mill blank in a manner substantially corresponding to a distribution, in a cured and milled dental article fabricated from the dental mill blank, of enamel in a natural tooth structure.

The natural tooth structure may include a tooth of a predetermined size. The dental mill blank may include a bar code affixed to the dental mill blank. The bar code may identify a distribution of the two or more materials by reference to one or more of a size, a shade, and a type of a dental article to be fabricated for the natural tooth structure from the dental mill blank. The bar code may identify the dental mill blank according to one or more of a batch number, a shape, and a shelf life. The one or more mechanical properties to support a tooth structure may include resistance to fracture. The one or more mechanical properties similar to enamel may include one or more of chip resistance, stain resistance, wear resistance, and polish retention. At least one of the SMC materials may include a resin system with a crystalline component, a filler system, and an initiator system. The at least one of the SMC materials may include: a resin system comprising at least one ethylenically unsaturated component and a crystalline component; greater than 60 wt-% of a filler system; and an initiator system; wherein the SMC material exhibits sufficient malleability at a temperature of about 15° C. to 38° C. At least one of the SMC materials may include a polymerizable compound and an organogelator. The organogelator may be a polymerizable organogelator. The cured and milled dental article may include a restoration. The restoration may include one or more of a crown, a bridge, an inlay, and an onlay.

In another aspect, a method disclosed herein includes providing a dental mill blank comprising two or more materials, the two or more materials being self-supporting, malleable, curable (SMC) materials, and the two or more materials including an internal material having one or more properties similar to dentin and an exterior material having one or more properties similar to enamel, the internal material and the external material having a spatial distribution within the dental mill blank such that a dental article fabricated from the dental mill blank has an exterior surface formed of the exterior material and an internal volume substantially formed of the internal material; milling a shape of a specific tooth structure of a patient from the dental mill blank; and curing the dental mill blank to provide a dental article.

The method may include deforming the dental mill blank to adapt the spatial distribution to the specific tooth structure of the patient. The method may include adhering the dental article to a site within dentition of the patient. The method may include partially curing the dental mill blank before milling the shape from the dental mill blank. The specific tooth structure may correspond to a tooth selected from the group consisting of an incisor, a canine, a pre-molar, and a molar. Milling the shape of the specific tooth structure may include milling a dental restoration. At least one of the SMC materials may include a resin system with a crystalline component, a filler system, and an initiator system. At least one of the SMC materials may include a polymerizable compound and an organogelator.

### BRIEF DESCRIPTION OF THE FIGURES

The invention and the following detailed description of certain embodiments thereof may be understood by reference to the following figures.

FIG. 1 shows a side view cross section of a compound dental mill blank.

FIG. 2 shows a top view cross section of a compound dental mill blank.

FIG. 3 shows a dental article milled from the compound dental mill blank.

FIG. 4 shows a process for fabricating a dental article from a compound dental mill blank.

### DETAILED DESCRIPTION

Described herein are a number of compound dental mill blanks and methods for using the blanks to fabricate dental articles. While the description emphasizes use of self-supporting, malleable, curable (SMC) materials, it will be understood that other materials may be suitably employed instead of, or in addition to SMC materials within a dental mill blank provided the resulting dental mill blank can be used in the manner described herein. For example, other materials that can be manipulated to accommodate various tooth shapes and cured to a hardness suitable for use in a dental restoration may be suitably employed in place of the SMC materials described herein. As another example, high-strength volume fillers such as ceramics or the like may be employed within a mill blank in regions that will neither be deformed to fit a dental application nor milled during the fabrication process without significantly limiting the advantages of the mill blanks described herein. Additional variations, adaptations, and combinations of the methods and systems below will be apparent to one of ordinary skill in the art, and all such variations, adaptations, and combinations are intended to fall within the scope of this disclosure.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives.

Unless explicitly indicated or otherwise clear from the context, the following conventions are employed in the following disclosure, and are intended to describe the full scope of the inventive concepts herein. All numbers expressing feature sizes, amounts, and physical properties used in the specification and claims are to be understood as being modified by the term “about.” Any numerical parameters set forth in this specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise. In a list, the term “or” means one or all of the listed elements or a combination of any two or more of the listed elements.

When a group is present more than once in a formula described herein, each group is “independently” selected, whether specifically stated or not. For example, when more than one M group is present in a formula, each M group is independently selected.

As used herein, the term “room temperature” refers to a temperature of 20° C. to 25° C. or 22° C. to 25° C.

The term “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “dental object”, as used herein, is intended to refer broadly to subject matter specific to dentistry. This may include intraoral structures such as dentition, and more typically human dentition, such as individual teeth, quadrants, full arches, pairs of arches which may be separate or in occlusion of various types, soft tissue, and the like, as well as bones and any other supporting or surrounding structures. As used herein, the term “intraoral structures” refers to both natural structures within a mouth as described above and artificial structures such as any of the dental objects described below that might be present in the mouth. As used herein, the term dental article is intended to refer to a man-made dental object. Dental articles may include “restorations”, which may be generally understood to include components that restore the structure or function of existing dentition, such as crowns, bridges, veneers, inlays, onlays, amalgams, composites, and various substructures such as copings, core build-ups, and the like, as well as temporary restorations for use while a permanent restoration is being fabricated. Dental articles may also include a “prosthesis” that replaces dentition with removable or permanent structures, such as dentures, partial dentures, implants, retained dentures, and the like. Dental articles may also include “appliances” used to correct, align, or otherwise temporarily or permanently adjust dentition, such as removable orthodontic appliances, surgical stents, bruxism appliances, snore guards, indirect bracket placement appliances, and the like. Dental articles may also include “hardware” affixed to dentition for an extended period, such as implant fixtures, implant abutments, orthodontic brackets, and other orthodontic components. Dental articles may also include “interim components” of dental manufacture such as dental models (full or partial), wax-ups, investment molds, and the like, as well as trays, bases, dies, and other components employed in the fabrication of restorations, prostheses, and the like. Dental objects may also be categorized as natural dental objects such as the teeth, bone, and other intraoral structures described above or as artificial dental objects (i.e., dental articles) such as the restorations, prostheses, appliances, hardware, and interim components of dental manufacture as described above. A dental article may be fabricated intraorally, extraorally, or some combination of these.

The following description emphasizes the use of self-supporting, malleable, curable (SMC) materials, also referred to herein as “hardenable compositions.” In general, an SMC material is self-supporting in the sense that the material has sufficient internal strength before curing to be formed into a desired shape that can be maintained for a period of time, such as to allow for transportation and storage. An SMC material is malleable in the sense that it is capable of being custom shaped and fitted under moderate force, such as a force that ranges from light finger pressure to that applied with manual operation of a small hand tool, such as a dental composite instrument. An SMC material is curable in the sense that it can be cured using light, heat, pressure or the like. For dental applications, the material may be both partially curable to improve rigidity during certain handling steps, and fully curable to a hardness suitable for use as a dental article. The forgoing characteristics are now discussed in greater detail.

The term “self-supporting” as used herein means that an article is dimensionally stable and will maintain its preformed shape without significant deformation at room temperature (i.e., about 20° C. to about 25° C.) for at least two weeks when free-standing (i.e., without the support of packaging or a container). In many embodiments, the mill blanks and articles milled from uncured blanks are dimensionally stable at room temperature for at least one month, or for at least six months. In some embodiments, the mill blocks described herein are dimensionally stable at temperatures above room temperature, or up to 40° C., or up to 50° C., or up to 60° C. This definition applies in the absence of conditions that activate any initiator system and in the absence of an external force other than gravity.

The terms “malleable” or having “sufficient malleability” as used herein in reference to SMC materials indicates that the material is capable of being custom-shaped and fitted onto a prepared tooth, or shaped into a suitable mill blank, under a moderate manual force (i.e., a force that ranges from light finger pressure to that applied with manual operation of a small hand tool, such as a dental composite instrument). The shaping, fitting, forming, etc., can be performed by adjusting the external shape and internal cavity shape of the compound SMC dental mill blank before, during, or after milling. In many embodiments, the SMC materials may exhibit the desired sufficient malleability at temperatures of, e.g., 40 degrees Celsius or less. In other instances, the SMC materials may exhibit “sufficient malleability” in a temperature range of, e.g., 15° C. to 38° C.

The term “curable” or “hardenable” are used interchangeably herein to refer to materials that can be cured to lose their sufficient malleability. The hardenable (i.e., curable) materials may be irreversibly hardenable, which, as used herein, means that after hardening such that the composition loses its malleability it cannot be converted back into a malleable form without destroying the external shape of the resulting product. Examples of some potentially suitable hardenable compositions that may be used to construct the dental mill blanks described herein with sufficient malleability may include, e.g., hardenable organic compositions (filled or unfilled), polymerizable dental waxes, hardenable dental compositions having a wax-like or clay-like consistency in the unhardened state, etc. In some embodiments, the dental mill blanks are constructed of hardenable compositions that consist essentially of non-metallic materials.

Numerous SMC materials are described, for example in the following references, each of which is incorporated herein by reference: U.S. patent application Ser. No. 10/921,648 to Karim et al. entitled Hardenable Dental Article and Method of Manufacturing the Same, filed on Aug. 19, 2004 and published on May 12, 2005 as U.S. Pub. No. 2005/0100868; U.S. patent application Ser. No. 10/749,306 to Karim et al. entitled Curable Dental Mill Blanks and Related Methods, filed on Dec. 31, 2003 and published on Jul. 7, 2005 as U.S. Pub. No. 2005/0147944; U.S. patent application Ser. No. 10/643,771 to Kvitrud et al. entitled Dental Crown Forms and Methods, filed on Aug. 19, 2003 and published on Feb. 24, 2005 as U.S. Pub. No. 2005/0042577; U.S. patent application Ser. No. 10/643,748 to Oxman et al. entitled Dental Article Forms and Methods, filed on Aug. 19, 2003 and published on Feb. 24, 2005 as U.S. Pub. No. 2005/0042576; U.S. patent application Ser. No. 10/219,398 to Karim et al. entitled Hardenable Self-Supporting Structures and Methods, filed on Aug. 15, 2002 and published on Jun. 19, 2003 as U.S. Pub. No. 2003/0114553; and International Patent Application No. US06/016197 to Karim et al. entitled Malleable Symmetric Dental Crowns. In addition, 3M™, of St. Paul, Minn., markets a shell temporization made of SMC material under the trade name PROTEMP™ Crown. More generally, any material having self-supporting, malleable, curable characteristics suitable for use in the compound mill blanks described herein may be suitably employed.

A number of potentially suitable SMC materials are now described in greater detail.

With respect to the hardenable compositions described in the references above, the unique combination of highly malleable properties (preferably without heating above room temperature or body temperature) before hardening (e.g., cure) and high strength (preferably, e.g., a flexural strength of at least about 25 MPa) after hardening may provide preformed compound dental mill blanks with numerous potential advantages. For example, a preformed compound dental mill blank that is sufficiently malleable can facilitate forming of a desired mill blank shape before milling, or facilitate fitting of the milled or un-milled blank onto a prepared tooth surface during a fitting process. Because the compositions are hardenable, the adjusted external shape can also be retained permanently as desired. As described above, useful hardenable compositions for the SMC materials described herein may include e.g., polymerizable waxes, hardenable organic materials (filled or unfilled), etc. Some potentially suitable hardenable compositions may include those described in U.S. Pat. No. 5,403,188 to Oxman et al.; U.S. Pat. No. 6,057,383 to Volkel et al.; and U.S. Pat. No. 6,799,969 to Sun et al.

The SMC materials described above may include a resin system that includes a crystalline component, greater than 60 percent by weight (wt-%) of a filler system (preferably, greater than 70 wt-% of a filler system), and an initiator system, wherein the hardenable composition exhibits sufficient malleability to be formed onto a prepared tooth, preferably at a temperature of about 15° C. to 38° C. (more preferably, about 20° C. to 38° C., which encompasses typical room temperatures and body temperatures). In some embodiments, the hardenable compositions do not need to be heated above body temperature (or even about room temperature) to become malleable as discussed herein.

At least a portion of the filler system of a hardenable composition may include particulate filler. In this and various other embodiments, if the filler system includes fibers, the fibers may be present in an amount of less than 20 wt-%, based on the total weight of the composition.

The crystalline component may provide a morphology that assists in maintaining the self-supporting first shape. This morphology includes a noncovalent structure, which may be a three-dimensional network (continuous or discontinuous) structure. If desired, the crystalline component can include one or more reactive groups to provide sites for polymerizing or crosslinking. If such crystalline components are not present or do not include reactive groups, or optionally where crystalline components are present and do include reactive groups, such reactive sites may be provided by another resin component, such as an ethylenically unsaturated component.

Thus, for certain embodiments, the resin system includes at least one ethylenically unsaturated component. Ethylenically unsaturated components can be selected from the group consisting of mono-, di-, or poly-acrylates and methacrylates, unsaturated amides, vinyl compounds (including vinyl oxy compounds), and combinations thereof. This ethylenically unsaturated component can be the crystalline component or noncrystalline.

The crystalline component can include polyesters, polyethers, polyolefins, polythioethers, polyarylalkylenes, polysilanes, polyamides, polyurethanes, or combinations thereof. The crystalline component can include saturated, linear, aliphatic polyester polyols containing primary hydroxyl end groups. The crystalline component can optionally have a dendritic, hyperbranched, or star-shaped structure, for example.

The crystalline component can optionally be a polymeric material (i.e., a material having two or more repeat units, thereby including oligomeric materials) having crystallizable pendant moieties and the following general formula:

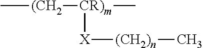

wherein R is hydrogen or a (C₁-C₄) alkyl group, X is —CH₂—, —C(O)O—, —O—C(O)—, —C(O)—NH—, —HN—C(O)—, —O—, —NH—, —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions.

Alternative to, or in combination with, the crystalline component, the hardenable composition can include a filler that is capable of providing a morphology to the composition that includes a noncovalent structure, which may be a three-dimensional network (continuous or discontinuous) structure, that assists in the maintenance of the first shape. In some embodiments, such a filler has nanoscopic particles, or the filler is an inorganic material having nanoscopic particles. To enhance the formation of the noncovalent structure, the inorganic material can include surface hydroxyl groups. In some embodiments, the inorganic material includes fumed silica.

In some embodiments, the composition includes, in addition to a resin system and an initiator system, either a crystalline component or a filler system that includes a particulate filler (e.g., a micron-size particulate filler, a nanoscopic particulate filler, a colloidal or fumed filler, a prepolymerized organic filler, or any combination of these), or both a crystalline component and a filler system. Furthermore, the use of one or more surfactants may also enhance the formation of such a noncovalent structure, and a surfactant system may optionally be employed. As used herein, a filler system includes one or more fillers and a surfactant system includes one or more surfactants.

Another potential embodiment may include a hardenable composition that includes a resin system, a filler system at least a portion of which is an inorganic material having nanoscopic particles with an average primary particle size of no greater than about 50 nanometers (nm), a surfactant system, and an initiator system. The hardenable composition can exhibit sufficient malleability to be formed onto a prepared tooth at a temperature of about 15° C. to 38° C. In embodiments with a surfactant system and nanoscopic particles, the resin system can include at least one ethylenically unsaturated component, and the filler system is present in an amount of greater than 50 wt-%.

In other embodiments, hardenable compositions may include a resin system that includes: a noncrystalline component selected from the group consisting of mono-, di-, or poly-acrylates and methacrylates, unsaturated amides, vinyl compounds, and combinations thereof; and a crystalline component selected from the group consisting of polyesters, polyethers, polyolefins, polythioethers, polyarylalkylenes, polysilanes, polyamides, polyurethanes, polymeric materials (including oligomeric materials) having crystallizable pendant moieties and the following general formula:

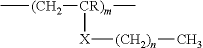

wherein R is hydrogen or a (C₁-C₄) alkyl group, X is —CH₂—, —C(O)O—, —O—C(O)—, —C(O)—NH—, —HN—C(O)—, —O—, —NH—, or —O—C(O)—NH—, —HN—C(O)—O—, —HN—C(O)—NH—, or —Si(CH₃)₂—, m is the number of repeating units in the polymer (preferably, 2 or more), and n is great enough to provide sufficient side chain length and conformation to form polymers containing crystalline domains or regions, and combinations thereof. The hardenable composition may further include greater than about 60 wt-% of a filler system and an initiator system. The hardenable composition can exhibit sufficient malleability to be formed onto a prepared tooth at a temperature of about 15° C. to 38° C. If the filler system includes fibers, the fibers may be present in an amount of less than 20 wt-%, based on the total weight of the hardenable composition.

In yet another embodiment, the hardenable compositions includes a resin system with a crystalline compound of the formula:

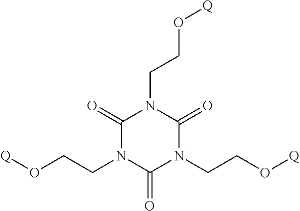

wherein each Q independently comprises polyester segments, polyamide segments, polyurethane segments, polyether segments, or combinations thereof; a filler system; and an initiator system.

The SMC material may include organogelators and polymerizable components that can be used in a variety of dental applications.

In one embodiment, the SMC material includes a polymerizable component, an organogelator, and a crystalline material. In another embodiment, the SMC material includes a hardenable dental composition that includes a polymerizable component, an organogelator, and 60% or more filler material. In another embodiment, the SMC material includes a hardenable dental composition that includes a polymerizable component, an organogelator, and filler material comprising nanoscopic particles. In another embodiment, the SMC material includes a hardenable dental composition that includes a polymerizable component and a polymerizable organogelator.

In certain embodiments, the hardenable composition can be in the form of a hardenable, self-supporting (i.e., free-standing) structure having a first shape. The self-supporting structure has sufficient malleability to be reformed into a second shape, thereby providing for simplified customization of a device, e.g., simplified customized fitting of a dental prosthetic device. Once reformed into a second shape, the composition can be hardened using, for example, a free radical curing mechanism under standard photopolymerization conditions to form a hardened composition with improved mechanical properties. Significantly, for certain embodiments of the compositions described herein, the hardened structure does not need an additional veneering material.

In certain embodiments, the hardenable composition includes an organogelator of the general formula (Formula I):

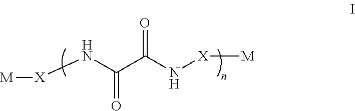

wherein each M is independently hydrogen or a polymerizable group; each X is independently an alkylene group, cycloalkylene group, arylene group, arenylene group, or a combination thereof, and n is 1 to 3. Such organogelators are also provided by the present invention.

Herein, an “organogelator” is a generally low molecular weight organic compound (generally no greater than 3000 g/mol) that forms a three-dimensional network structure when dissolved in an organic fluid, thereby immobilizing the organic fluid and forming a non-flowable gel that exhibits a thermally reversible transition between the liquid state and the gel state when the temperature is varied above or below the gel point of the mixture.

Herein, the “polymerizable component” can include one or more resins, each of which can include one or more monomers, oligomers, or polymerizable polymers.

The compositions described herein have numerous potential applications, including use in fabricating a number of the dental articles described above. These applications include, but are not limited to, dental restoratives and dental prostheses, including, but not limited to, temporary, intermediate/interim, and permanent crowns and bridges, inlays, onlays, veneers, implants, abutments for implants, core build-ups, dentures, and artificial teeth, as well as dental impression trays, orthodontic appliances (e.g., retainers, night guards), orthodontic adhesives, tooth facsimiles or splints, maxillofacial prostheses, and other customized structures.

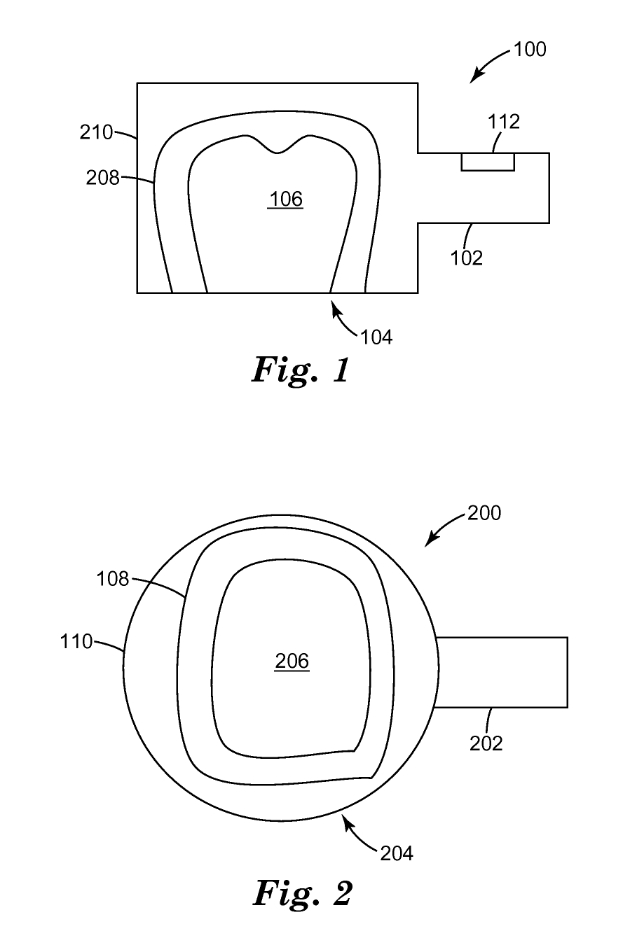

FIG. 1 shows a side view cross section of a compound dental mill blank. In general, a compound dental mill blank 100 includes a stem 102 and a body 104 that includes a volume encompassing an internal material 106, an exterior material 108, and an outer layer 110. The dental mill blank 100 may also optionally include an identifier 112 such as a bar code or Radio-Frequency Identification (RFID) tag.

The stem 102 may optionally be provided to support the blank 100 during milling or other handling, and may be shaped to fit into a corresponding chuck or other support of a milling machine or similar hardware for shaping the blank 100 through the selective removal of material therefrom. In some embodiments, the stem 102 may be cured prior to milling for improved mechanical support of the blank 100.

A milling machine (not shown) for milling as described herein may include, for example, a Computerized Numerically Controlled (“CNC”) milling machine with an arm and a cutting tool that cooperate to mill a workpiece under computer control. Milling is generally a subtractive technology in that material is subtracted from a block rather than added. Thus pre-cut workpieces approximating commonly milled shapes may advantageously be employed to reduce the amount of material that must be removed during a milling job, which may reduce material costs or save time in a milling process. More specifically in a dental context, it may be advantageous to begin a milling process with a precut piece, such as a generic coping, rather than a square block. Thus, while a particular shape is shown in FIG. 1, it will be understood that any number of shapes and sizes may be employed as the blank 100 described herein. The size may vary, for example, according to a corresponding size of a target restoration design. The shape may vary, for example, according to a type of tooth being replaced or repaired, or the particular type of restoration (e.g., a bridge, crown, inlay, onlay, veneer, etc.). The tooth type may include, for example, a molar, a pre-molar, a canine, or an incisor. For a bridge or the like, the dental mill blank 100 may be shaped and sized to correspond to a number of adjacent teeth. Various milling systems have different degrees of freedom, referred to as axes. Typically, the more axes available (such as 4-axis milling), the more accurate the resulting parts. High-speed milling systems are commercially available, and can provide high throughputs. In addition a milling system may use a variety of cutting tools, and the milling system may include an automated tool changing capability to cut a single part with a variety of cutting tools. In milling a dental model, accuracy may be adjusted for different parts of the model. For example, the tops of teeth, or occlusal surfaces, may be cut more quickly and roughly with a ball mill and the prepared tooth and dental margin may be milled with a tool resulting in greater detail and accuracy. CNC milling and other milling technologies can be employed for manufacturing dental models, dental model components, wax-ups, investment chambers, and other dental objects, any of which may be suitably fashioned from compound dental mill blanks as described herein. In addition specialty dental milling equipment exists, such as the Cerac system from Sirona Dental. Another useful milling system for the dental fabrication processes described herein is a copy milling system that permits manual or automated transfer of a three-dimensional form from a physical object to a milled target. More generally, “milling” as used herein may refer to any subtractive process in which material is removed from a workpiece including abrading, polishing, controlled vaporization, electronic discharge milling (EDM), cutting by water jet or laser or any other method of cutting, removing, shaping or carving material. All such milling systems as may be adapted for use with the dental mill blanks 100 described herein are intended to fall within the scope of the term “milling” as used herein. Inputs to the milling system may be provided from three-dimensional scans of dentition, three-dimensional scans of working models, CAD/CAM models, or any other suitable source.

The body 104 may have any shape and size suitable for accommodating the internal material 106 and exterior material 108 as described below, and may further include an optional outer layer 110 as described generally below. It will be understood that the blank 100 may be selected or fabricated to match a predetermined tooth size, as determined for example by direct measurement of a site for which a restoration or the like is to be fabricated.

The internal material 106 may be any of the SMC materials described above. The internal material 106 may be spatially distributed within the dental mill blank in a manner substantially corresponding to a distribution, in a cured and milled dental article fabricated from the blank 100, of dentin in a natural tooth structure. This distribution may vary according to the size or type of tooth for which a dental article is to be milled. For example, for a restoration the distribution may vary according to whether the restoration is a crown, a bridge, an inlay, an onlay, or a veneer. The internal material 106 may be selected to achieve one or more optical properties identical to or similar to dentin in a dental article milled from the blank 100. Thus for example the internal material 106 may be selected to have a translucence, color, or shade matching that of dentin, or may be selected to provide an appearance in the resulting restoration of the desired optical property or properties. Similarly, the internal material 106 may be selected to achieve on or more mechanical (i.e., structural) properties identical to or similar to dentin in a cured dental article milled from the blank 100. Thus for example the internal material 106 may be selected to support a tooth structure in ordinary use, or more generally to provide a desired degree of resistance to fracture, hardness, pliability or the like to a core region of a restoration. In particular, these characteristics may be selected to match the corresponding mechanical properties of a natural tooth structure in a cured dental article fabricated from the blank 100.

The exterior material 108 may be any of the SMC materials described above. The exterior material 108 may be spatially distributed within the dental mill blank in a manner substantially corresponding to a distribution, in a cured and milled dental article fabricated from the blank 100, of enamel in a natural tooth structure. While the interior surface of this material 108 is defined by a mating exterior surface of the internal material 106, the exterior surface of the exterior material 108 may extend as appropriate to provide a required buffer for milling on all surfaces. The exterior material 108 may optionally extend to the extent of the body 104, thus omitting any separate outer layer 110 from the mill blank. The distribution of the exterior material 108 may vary according to the size or type of tooth for which a dental article is to be milled. For example, for a restoration the distribution may vary according to whether the restoration is a crown, a bridge, an inlay, an onlay, or a veneer. The exterior material 108 may be selected to achieve one or more optical properties identical to or similar to enamel in a dental article milled from the blank 100. Thus for example the exterior material 108 may be selected to have a translucence, color, or shade matching that of enamel, or may be selected to provide an appearance in the resulting restoration of the desired optical property or properties. Similarly, the exterior material 108 may be selected to achieve on or more mechanical (i.e., structural) properties identical to or similar to enamel in a cured dental article milled from the blank 100. Thus for example the exterior material 108 may be selected to provide a desired hardness, chip resistance, stain resistance, wear resistance, polish retention, and the like to an external surface of a restoration. In particular, these characteristics may be selected to match the corresponding mechanical properties of a natural tooth structure in a cured dental article fabricated from the blank 100.

It will be understood that, while the distribution of materials may be carefully controlled to achieve a distribution more exactly corresponding to a distribution of enamel and dentin in a natural tooth structure, this distribution may be varied according to the capability of particular SMC materials to match the aesthetic and structural properties of the tooth structure being replaced. Thus while at a high level the distribution should result in the exterior material 108 appearing on external surfaces of a milled dental article and an internal material within a majority of the volume of the milled dental article, the foregoing description should not be construed to require a precise match between the distribution of SMC materials in the mill blank 100 and the distribution of enamel and dentin in a natural tooth structure.

The outer layer 110 may optionally be provided to serve any number of auxiliary functions. This may include, for example, shaping the blank 100 for convenient handling, packaging, or shipping, as well as protecting the interior of the blank prior to milling, such as to avoid unwanted deformation during stacking or substantial temperature excursions. The outer layer 110 may be millable, or otherwise removable from the blank 100 prior to milling.

The mill blank 100 may optionally include an identifier 112. The identifier 112 may be a bar code, RFID tag, or other identifier that uniquely identifies the blank 100 or associates the blank 100 with one or more properties. The identifier 112 may, for example, be a bar code, serial number, or other human-readable or machine-readable indicia on an exterior surface of the blank 100. The identifier 112 may also be affixed to packaging for the blank 100. The identifier 112 may also, or instead, include an RFID tag or the like physically embedded within the blank 100. In these latter embodiments, the RFID tag may be positioned in a portion of the blank, such as the outer layer 110, that is intended to be removed by milling, or the RFID tag may be positioned within the internal material 106 so that a restoration or other dental article fabricated from the blank 100 carries the information within the RFID tag. In one embodiment, the identifier 112 may encode a unique identification number for the blank 100. This number may be used to obtain any information cross-referenced to that unique number, which may include data concerning the spatial distribution of SMC materials, the size, shade, and type of SMC materials or dental articles milled therefrom, and any other data useful to a dentist preparing a dental article from the mill blank 100, or useful to a machine such as a computer-controlled milling machine that operates on the mill blank 100. In another aspect, the identifier 112 may directly encode data concerning the blank such as a batch number, a shape, a shelf life, and so forth. More generally, any information useful for handling or using the blank 100 may be encoded directly within the identifier 112, or obtained using a unique identifier encoded within the identifier 112. It will be appreciated that the identifier 112 may also, or instead, encode non-unique information that is in turn used to obtain relevant data for the blank 100. All such variations to and combinations of the foregoing are intended to fall within the scope of this disclosure.

FIG. 2 shows a top view cross section of a compound dental mill blank. This dental mill blank 200 may be, for example, the dental mill blank 100 from FIG. 1, and may similarly include a stem 202 and a body 204 that includes a volume encompassing an internal material 206, an exterior material 208, and an outer layer 210. As previously described, it will be understood that the exemplary representation of FIG. 2 in no way limits the scope of this disclosure. In practice, the mill blank 200 may have a wide variety of shapes, sizes, and distributions of material according to a type of tooth, size of tooth, type of restoration, anticipated shrinkage during curing, and so forth. All such variations as would be apparent to one of ordinary skill in the art are intended to fall within the scope of this disclosure.

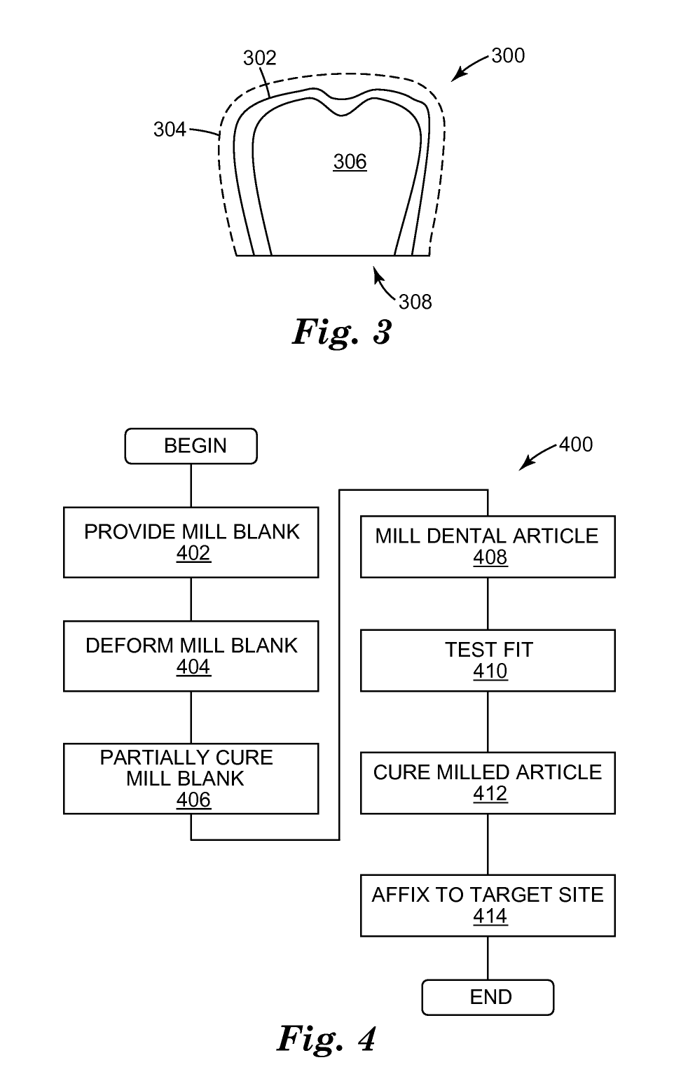

FIG. 3 shows a dental article 300 milled from the compound dental mill blank 100 of FIG. 1. The dental article 300, which may be a crown or the like, may have an exterior surface 302 milled from the exterior material 108 of the mill blank 100. The exterior surface 302 may, in general, match the appearance and function of enamel in a natural tooth structure that the dental article 300 is intended to replace. An appropriate shape may be imparted to the exterior surface 302 using any of the subtractive milling techniques described above. The envelope 304 of the exterior material 108 from the mill blank 100 is also shown for reference, although it does not form a part of the structure in FIG. 3. An interior structure 306 may be formed of the internal material 106 of the mill blank 100 of FIG. 1, and may in general provide structural support for the dental article 300. While a bottom surface 308 of the article 300 is depicted as a flat surface, it will be understood that in general the bottom surface 308 will be shaped to match a prepared tooth surface where the dental article 300 is to be affixed within human dentition.

FIG. 4 shows a process for fabricating a dental article from a compound dental mill blank.

The process 400 may begin by providing a mill blank, as shown in step 402. The mill blank may be any of the compound SMC dental mill blanks described above. The mill blank may be selected using any of the criteria described above including, for example, the shape of a desired restoration, the size of a tooth being restored, the type of tooth being restored, and optical characteristics such as color, shade, opacity, and so forth. These criteria may be objectively determined using image analysis or the like, or may be subjectively determined by a dental professional such as during a patient visit. In one aspect, a suitable mill blank may be selected using a bar code, RFID tag, or other identifier attached to or imprinted on the mill blank.

As shown in step 404, the mill blank may be deformed. This may be, for example, a controlled deformation to adapt the mill blank to a specific tooth structure of a dental patient, such as by adapting the mill blank to a particular tooth shape or size. As a significant advantage, this technique may permit a significant reduction in the types of mill blanks required for a range of restorations and other dental procedures. Deformation may be performed, for example, by direct manual deformation of the blank by a dental professional or technician, or using a tool or machine adapted to apply incremental changes along a dimension such as the height or width of the mill blank.

As shown in step 406, the blank may be partially cured. This may include, for example, curing to preserve the deformation applied in step 404 during milling, or more generally curing the blank to prepare for milling. This may also include partial spatial curing, such as curing the stem or other support structures for the mill blank. It will be appreciated that such interim curing steps are optional, and will depend on the particular milling procedure and SMC materials being used, as well as the dental article being fabricated.

As shown in step 408, the mill blank may then be milled into a dental article using any of the milling techniques described above. As generally noted above, the milled dental article may be a restoration such as a crown, a bridge, an inlay, an onlay, a veneer, and the like, as well as any other dental article that replaces natural dentition. For example, the techniques described herein may be suitably adapted to the manufacture of a prosthesis such as a denture or implant.

All such milling systems as may be adapted for use with the dental mill blanks described herein are intended to fall within the scope of the term “milling” as used herein, and a milling process may employ any such milling systems. More generally, as used herein “milling” may refer to any subtractive process including abrading, polishing, controlled vaporization, electronic discharge milling (EDM), cutting by water jet or laser or any other method of cutting, removing, shaping or carving material, unless a different meaning is explicitly provided or otherwise clear from the context. Inputs to the milling system may be provided from three-dimensional scans of dentition using, e.g., any suitable three-dimensional scanning system, three-dimensional scans of working models (which may also be created from a three-dimensional scan), CAD/CAM models (which may also be derived from a three-dimensional scan), or any other suitable source. It should be further understood that, while milling is one example of a digitally-subtractive technique, and a computer-controlled milling machine is a readily commercially available digitally-subtractive device, that other techniques for removing material under computer control are also known, and may be suitably adapted to use as a digitally-subtractive method or system as disclosed herein. This includes, for example, cutting, skiving, sharpening, lathing, abrading, sanding, and the like. Such uses are intended to fall within the scope of this disclosure.

As shown in step 410, the milled dental article may be test fit to a site in a patient's dentition. This may be performed directly on a patient's dentition, or using a dental model, an articulator, or the like. Any number of test fits may be performed, after which manual adjustments or re-milling may be performed to adjust occlusal fit, proximal contacts, and the like.

As shown in step 412, once an adequate fit has been achieved the article may be cured to final hardness.

As shown in step 414, the milled, shaped, and cured article may be permanently affixed to a target site in a patient's dentition such as by adhering the article using any number of suitable dental adhesives.

It will be understood that the above process 400 is merely exemplary. Any number of adaptations may be made, and steps may be added or removed from the process 400 as described. For example, in one aspect, the entire dental article may be retained in an at least partially uncured state until the article is permanently affixed to a target site. In another aspect, the entire article except for the portion mating to a prepared tooth surface may be fully cured, with malleability preserved at the mating surface to achieve a closer final fit. In another aspect, the article may be fully cured after milling, with subsequent adjustments performed in a conventional fashion with dental grinding tools. All such variations as would be clear to one of ordinary skill in the art are intended to fall within the scope of this disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law.

What is claimed is:

1. A dental mill blank comprising two or more materials, the two or more materials being self-supporting, malleable, curable (SMC) materials, and the two or more materials including an internal material having one or more optical properties similar to dentin and an exterior material having one or more optical properties similar to enamel, the internal material and the external material being spatially distributed within the dental mill blank in a manner substantially corresponding to a distribution, in a cured and milled dental article, of dentin and enamel in a natural tooth structure.

2. The dental mill blank of claim 1 wherein the cured and milled dental article includes a restoration.

3. The dental mill blank of claim 2 wherein the restoration includes one or more of a crown, a bridge, an inlay, and an onlay.

4. The dental mill blank of claim 1 wherein the natural tooth structure includes a tooth of a predetermined size.

5. The dental mill blank of claim 1 further comprising a bar code affixed to the dental mill blank.

6. The dental mill blank of claim 5 wherein the bar code identifies a distribution of the two or more materials by reference to one or more of a size, a shade, and a type of a dental article to be fabricated for the natural tooth structure from the dental mill blank.

7. The dental mill blank of claim 5 wherein the bar code identifies the dental mill blank according to one or more of a batch number, a shape, and a shelf life.

8. The dental mill blank of claim 1 wherein the two or more materials include an interior material resistant to fracture and an exterior material providing one or more characteristics similar to enamel.

9. The dental mill blank of claim 8 wherein the one or more characteristics includes one or more of chip resistance, stain resistance, wear resistance, and polish retention.

10. The dental mill blank of claim 1 wherein at least one of the SMC materials includes a resin system with a crystalline component, a filler system, and an initiator system.

11. The dental mill blank of claim 10 wherein the at least one of the SMC materials includes:
a resin system comprising at least one ethylenically unsaturated component and a crystalline component;
greater than 60 wt-% of a filler system; and
an initiator system;
wherein the SMC material exhibits sufficient malleability at a temperature of about 15° C. to 38° C.

12. The dental mill blank of claim 1 wherein at least one of the SMC materials includes a polymerizable compound and an organogelator.

13. The dental mill blank of claim 12 wherein the organogelator is a polymerizable organogelator.

14. A dental mill blank comprising two or more materials, the two or more materials being self-supporting, malleable, curable (SMC) materials, and the two or more materials including an internal material having one or more mechanical properties to support a tooth structure and an exterior material having one or more mechanical properties similar to enamel, the external material being spatially distributed within the dental mill blank in a manner substantially corresponding to a distribution, in a cured and milled dental article fabricated from the dental mill blank, of enamel in a natural tooth structure.

15. The dental mill blank of claim 14 wherein the natural tooth structure includes a tooth of a predetermined size.

16. The dental mill blank of claim 14 further comprising a bar code affixed to the dental mill blank.

17. The dental mill blank of claim 16 wherein the bar code identifies a distribution of the two or more materials by reference to one or more of a size, a shade, and a type of a dental article to be fabricated for the natural tooth structure from the dental mill blank.

18. The dental mill blank of claim 16 wherein the bar code identifies the dental mill blank according to one or more of a batch number, a shape, and a shelf life.

19. The dental mill blank of claim 14 wherein the one or more mechanical properties to support a tooth structure include resistance to fracture.

20. The dental mill blank of claim 14 wherein the one or more mechanical properties similar to enamel include one or more of chip resistance, stain resistance, wear resistance, and polish retention.

21. The dental mill blank of claim 14 wherein at least one of the SMC materials includes a resin system with a crystalline component, a filler system, and an initiator system.

22. The dental mill blank of claim 21 wherein the at least one of the SMC materials includes:
a resin system comprising at least one ethylenically unsaturated component and a crystalline component;
greater than 60 wt-% of a filler system; and
an initiator system;
wherein the SMC material exhibits sufficient malleability at a temperature of about 15° C. to 38° C.

23. The dental mill blank of claim 14 wherein at least one of the SMC materials includes a polymerizable compound and an organogelator.

24. The dental mill blank of claim 23 wherein the organogelator is a polymerizable organogelator.

25. The dental mill blank of claim 14 wherein the cured and milled dental article includes a restoration.

26. The dental mill blank of claim 25 wherein the restoration includes one or more of a crown, a bridge, an inlay, and an onlay.

27. A method comprising:
providing a dental mill blank comprising two or more materials, the two or more materials being self-supporting, malleable, curable (SMC) materials, and the two or more materials including an internal material having one or more properties similar to dentin and an exterior material having one or more properties similar to enamel, the internal material and the external material having a spatial distribution within the dental mill blank such that a dental article fabricated from the dental mill blank has an exterior surface formed of the exterior material and an internal volume substantially formed of the internal material;
milling a shape of a specific tooth structure of a patient from the dental mill blank; and
curing the dental mill blank to provide a dental article.

28. The method of claim 27 further comprising deforming the dental mill blank to adapt the spatial distribution to the specific tooth structure of the patient.

29. The method of claim 27 further comprising adhering the dental article to a site within dentition of the patient.

30. The method of claim 27 further comprising partially curing the dental mill blank before milling the shape from the dental mill blank.

31. The method of claim 27 wherein the specific tooth structure corresponds to a tooth selected from the group consisting of an incisor, a canine, a pre-molar, and a molar.

32. The method of claim 27 wherein milling the shape of the specific tooth structure includes milling a dental restoration.

33. The method of claim 27 wherein at least one of the SMC materials includes a resin system with a crystalline component, a filler system, and an initiator system.

34. The method of claim 27 wherein at least one of the SMC materials includes a polymerizable compound and an organogelator.
